(19) United States
(12) Patent Application Publication
(10) Pub. No.: US 2014/0168454 A1
(43) Pub. Date: Jun. 19, 2014

(54) Image Capture Device and Anti-shake Control Method Thereof

(71) Applicants: Asia Optical International Ltd., Tortola (GB); Sintai Optical (Shenzhen) Co., Ltd., Shenzhen City (CN)

(72) Inventors: Hsiang-Yin Lin, Taichung (TW); Lin-Chieh Kao, Taichung (TW)

(73) Assignees: Asia Optical International Ltd., Tortola (GB); Sintai Optical (Shenzhen) Co., Ltd., Shenzhen City (CN)

(21) Appl. No.: 14/108,425

(22) Filed: Dec. 17, 2013

(30) Foreign Application Priority Data
Dec. 19, 2012 (TW) 101148451

(51) Int. Cl. H04N 5/232

(52) U.S. Cl. CPC H04N 5/23264
USPC 348/208.99

(57) ABSTRACT

An image capture device and anti-shake control method thereof are provided. The image capture device includes a command input unit, a lens unit, a vibration compensation unit, and a control unit. The anti-shake control method is performed by using the control unit to compare the zoom ratio of the lens unit with a predetermined value. When the zoom ratio is greater than or equals the predetermined value, the vibration compensation unit is enabled. When the zoom ratio is less than the predetermined value, the vibration compensation unit is disabled unless a first motion acts on the command input unit.

### BACKGROUND OF THE INVENTION

1. Field of the Invention

The invention relates to an image capture device and an anti-shake control method thereof.

2. Description of the Related Art

For traditional cameras or digital cameras, camera shakes in taking photos are disadvantageous to image stability. The anti-shake techniques for solving camera shakes can be classified into several categories: optical image stabilization, CCD image stabilization, digital image stabilization, etc.

A digital camera with functions of optical image stabilization mostly has two anti-shake options. The first option is to enable the anti-shake function when user half presses the shutter button, and the anti-shake function is disabled when user releases the shutter button. The second option is to keep the anti-shake function enabled not matter whether user half presses the shutter button or not.

The benefit of the second option is a quicker response, especially for taking pictures at any time. The second option can afford instant anti-shake function to avoid losing immediate picture-taking opportunity. The first option needs half pressing the shutter button to enable the anti-shake function so that user could lose immediate picture-taking opportunity with a time lag. However, the second option has higher power consumption than the first option to shorten the battery working hours.

Most digital cameras are provided with zoom lenses, the zoom ratios of which have been developed from 2, 3, and 5 times in early stages, through 10 and 12 times, to 15, 20, 30, and even 50 times recently. In operation of a digital camera at a high zoom ratio, if the first option is chosen for avoiding high power consumption, then the immediate picture-taking opportunity could be lost due to no instant anti-shake function. To avoid that, the shutter button is necessarily kept half pressed throughout the operation in the browse mode to enable the anti-shake function for image stabilization. However, operation is such a way is not convenient to users. In operation of a digital camera at a low zoom ratio, if the second option is chosen for instant anti-shake function, then the digital camera will have a high power consumption to shorten the battery working hours.

### BRIEF SUMMARY OF THE INVENTION

According to the above or other objects, the invention provides an image capture device and an anti-shake control method thereof When the zoom ratio of the image capture device is greater than or equals a predetermined value, the compensation module is kept enabled during focus adjustment no matter whether the command input unit (such as physical shutter button, touch panel, etc.) is half pressed or under another equivalent action. Thus, good image stabilization at high zoom ratio can be achieved and there is no need to keep half pressing the command input unit to enable the compensation module in browse mode. When the zoom ratio of the image capture device is less than the predetermined value, the vibration compensation unit is disabled unless a half-press (or another equivalent motion) acts on the command input unit for focus adjustment. When the half-press or equivalent motion is released from the command input unit, the vibration compensation mode is exited and the battery working hours can lengthen thereby.

In an exemplary embodiment, the anti-shake control method of an image capture device in accordance with the invention includes: comparing a zoom ratio of the image capture device with the predetermined value; entering a vibration compensation mode when the zoom ratio is greater than or equals the predetermined value; exiting the vibration compensation mode when the zoom ratio is smaller than the predetermined value; and entering the vibration compensation mode when the zoom ratio is smaller than the predetermined value and a first motion acts on a command input unit of the image capture device.

In another exemplary embodiment, the command input unit can be a physical shutter button or a touch panel.

In yet another exemplary embodiment, the aforementioned first motion can be: half pressing the command input unit, or a short touch on the command input unit, or performing a first sliding motion on the command input unit.

In another exemplary embodiment, the anti-shake control method of the image capture device in accordance with the invention further includes: performing a focus adjustment after entering the vibration compensation mode due to the first motion acting on the command input unit.

In yet another exemplary embodiment, after performing the focus adjustment, the anti-shake control method of the image capture device in accordance with the invention further includes: exiting the vibration compensation mode when the first motion is released and a second motion has not acted on the command input unit yet.

In another exemplary embodiment, the aforementioned second motion includes: full pressing the command input unit, or another short touch on the command input unit, or a long touch on the command input unit, or performing a second sliding motion on the command input unit.

In yet another exemplary embodiment, after performing the focus adjustment, the anti-shake control method of the image capture device in accordance with the invention further includes: performing a photographic exposure when a second motion acts on the command input unit.

In another exemplary embodiment, the aforementioned second motion includes: full pressing the command input unit, or another short touch on the command input unit, or a long touch on the command input unit, or performing a second sliding motion on the command input unit.

In yet another exemplary embodiment, after performing the photographic exposure, the anti-shake control method of the image capture device in accordance with the invention further includes: exiting the vibration compensation mode when the first motion and second motion are released.

In another exemplary embodiment, the aforementioned predetermined value is 15 times.

In a perspective of the invention, an exemplary embodiment of the image capture device is provided. The image capture device includes: a lens unit, a vibration compensation unit, and a control unit. The focus of the lens unit is adjustable to include a zoom ratio. The control unit enables or disables the vibration compensation unit according to the zoom ratio of the lens unit.

In another exemplary embodiment, the image capture device in accordance with the invention further includes a command input unit. The control unit enables or disables the vibration compensation unit in accordance with an external motion acting on the command input unit.

In yet another exemplary embodiment, the image capture device in accordance with the invention further includes a focus adjusting button to control the focus of the lens unit through the control unit.

In another exemplary embodiment, the aforementioned predetermined value is 15 times.

In yet another exemplary embodiment, the image capture device can be a mobile phone, a camera, or a video recorder.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates an image capture device in accordance with an embodiment of the invention;

FIGS. 2A, 2B, and 2C are a flow chart of an anti-shake control method of an image capture device in accordance with an embodiment of the invention.

### DETAILED DESCRIPTION OF THE INVENTION

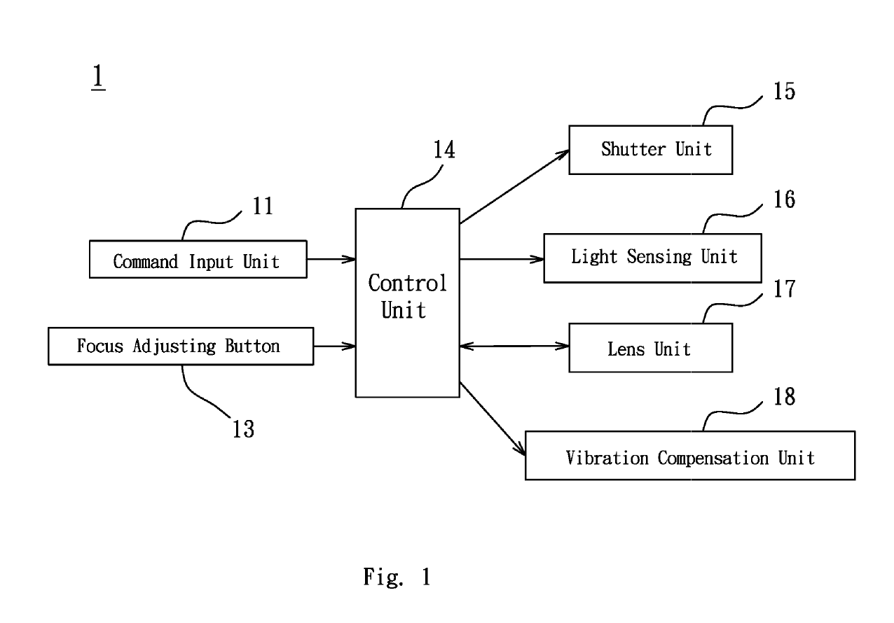

FIG. 1 illustrates an image capture device in accordance with an embodiment of the invention. The image capture device 1 (such as camera, video recorder, mobile phone, etc.) includes a command input unit 11, a focus adjusting button 13, a control unit 14, a shutter unit 15, a light sensing unit 16, a lens unit 17 and a vibration compensation unit 18, which are detailed as follows.

The command input unit 11 can control the shutter unit 15, through the control unit 14, to open for exposing the light sensing unit 16 or to be closed without exposing the light sensing unit 16, wherein the command input unit 11 may be a physical shutter button or a touch panel. The image capture device 1 is capable of operating in a first stage operation mode, a second stage operation mode, or a third stage operation mode, which depends on user's motions. The first stage operation mode is entered by a first motion of the user. When the command input unit 11 is a physical shutter button, the first motion may be half pressing the command input unit 11. When the command input unit 11 is a touch panel, the first motion may be a short touch or a first sliding motion acting thereon. The command input unit 11 generates a first status signal to the control unit 14 when the first motion acts on the command input unit 11. The second stage operation mode is entered by a second motion of the user. When the command input unit 11 is a physical shutter button, the second motion may be full pressing the command input unit 11. When the command input unit 11 is a touch panel, the second motion may be another short touch or a long touch or a second sliding motion acting thereon. The command input unit 11 generates a second status signal to the control unit 14 when the second motion acts on the command input unit 11. The third stage operation mode is entered by releasing the first or second motion no matter the command input unit 11 is a physical button or a touch panel. When the first and second motions are released, the command input unit 11 generates a release status signal to the control unit 14.

The focus adjusting button 13 affords a user manual control to generate a signal to the control unit 14 that the focus adjusting button 13 controls the focus adjustment of the lens unit 17 through the control unit 14.

The shutter unit 15 can be opened for exposing the light sensing unit 16 or closed without exposing the light sensing unit 16.

The light capture unit 16 can transform received light (or a light signal) into an electrical signal after the photographic exposure. After a following digital image processing, the electrical signal is stored as image data in a memory unit (not shown).

The lens unit 17 can perform a manual zoom adjustment or an autofocus operation after receiving the command (or the signal) from the control unit 14.

The vibration compensation unit 18 can be enabled or disabled according to the command (or signal) from the control unit 14 to reduce the hand shake effect for a stable captured image.

The control unit 14 is capable of: receiving the signal from the focus adjusting button 13 to adjust a zoom ratio of the lens unit 17; generating a signal to the lens unit 17 to enable the autofocus function; receiving a signal from the command input unit 11 to control the shutter unit 15 to enable or disable for exposing the light capture unit 16 or not; generating a signal to relocate each light sensing element in the light capture unit 16; and enabling or disabling the vibration compensation unit 18 according to the zoom ratio of the lens unit 17 and the motion acting on the command input unit 11.

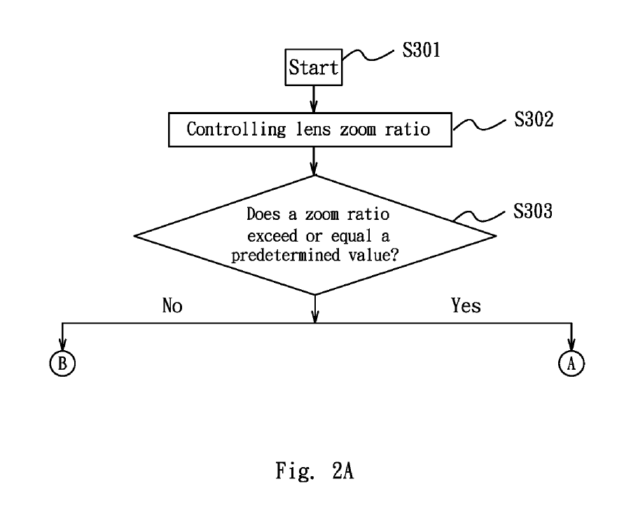

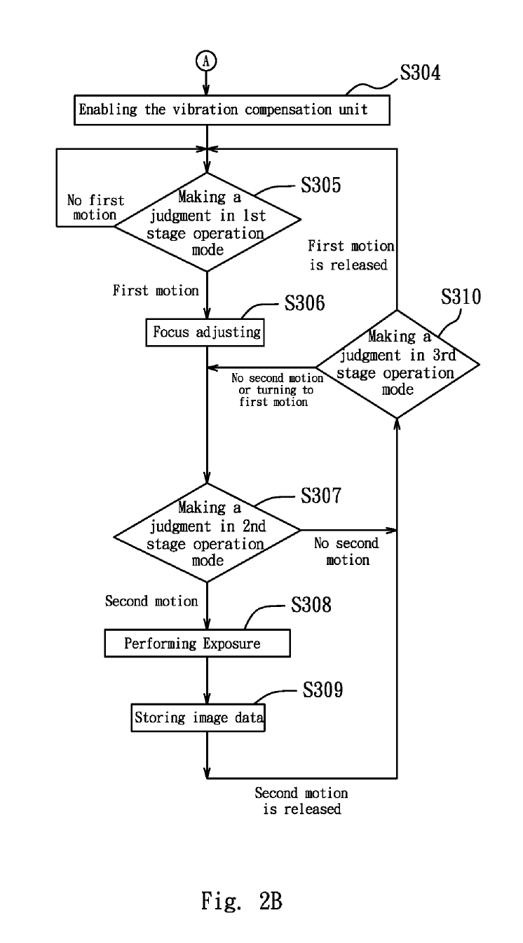

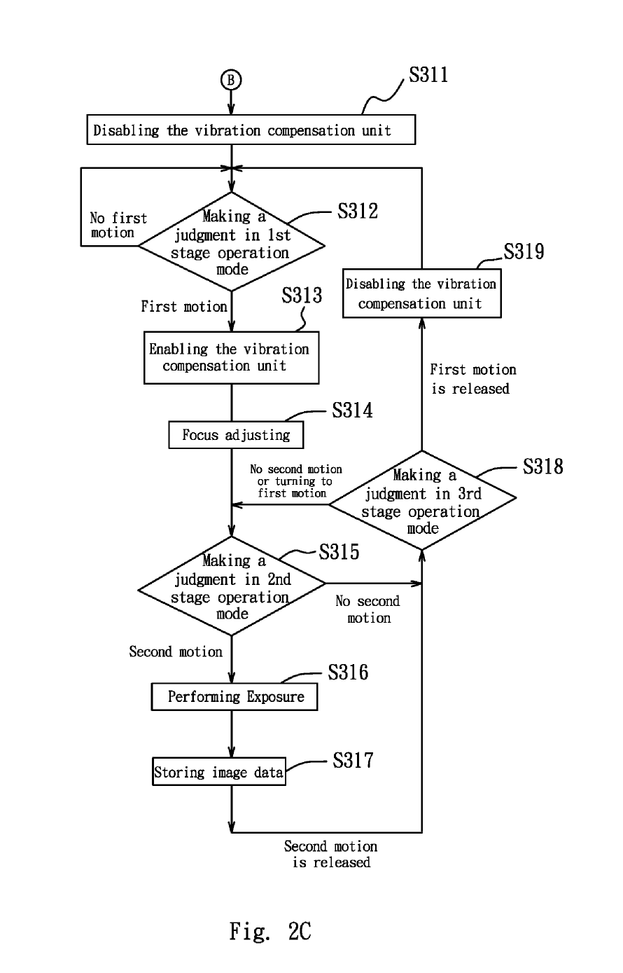

FIGS. 2A, 2B, and 2C are a flow chart of an anti-shake control method of an image capture device in accordance with an embodiment of the invention. Briefly, the anti-shake control method of an image capture device is executed by comparing a zoom ratio of the image capture device with a predetermined value (such as 15 times) (step S303). A vibration compensation mode for shooting image is entered when the zoom ratio is greater than or equals the predetermined value (in a high zoom ratio situation) (steps S304-S310), which enables the image capture unit to be capable of clear image quality at high room ratio situation and offers a stable image in browse mode without half pressing for a long time or touching the command input unit. The vibration compensation mode is exited when the zoom ratio is less than the predetermined value (in a low zoom ratio situation), and the vibration compensation mode can be entered again by half pressing or touching the command input unit of the image capture device (steps S311-S319). Therefore, the power consumption can be reduced by the aforementioned steps. The description of the anti-shake control method is detailed as follows with reference to FIGS. 2A, 2B, and 2C.

Step S301 is performed to start (power on) the image capture device 1. Then, a step S302 is performed.

Step S302 is performed to control the lens zoom ratio. Controlling the lens zoom ratio includes an autofocus control or a manual zoom control. The autofocus control means that the control unit 14 generates a signal to the lens unit 17 for setting the zoom ratio of the lens unit 17 according to an initial value, and receives a feedback of the zoom ratio from the lens unit 17. The manual zoom control means that user touches or presses the focus adjusting button 13 to generate a signal to the control unit 14, and the control unit 14 controls the zoom ratio of the lens unit 17, and the lens unit 17 feedbacks the zoom ratio to the control unit 14. Afterward, a step S303 is performed.

Step S303 is performed to judge whether the zoom ratio is greater than the predetermined value or not, wherein the zoom ratio is compared with the predetermined value when the control unit 14 receives the zoom ratio from the lens unit 17. If the zoom ratio exceeds or equals the predetermined value, a step S 304 is performed to enable the vibration compensation unit 18. If the zoom ratio is less than the predetermined value, a step S 311 is performed to disable the vibration compensation unit 18.

Step S304 is performed to enable the vibration compensation unit 18. Specifically, the control unit 14 generates a signal to the vibration compensation unit 18 for enabling the vibration compensation unit 18, and a step S305 is afterward performed.

Step S305 is performed to make a judgment in the first stage operation mode. In detail, the command input unit 11 generates the first status signal to the control unit 14 when the user performs the first motion on the command input unit 11 (for example, half pressing the command input unit 11, or a short touch on the command input unit 11, or performing a first slide motion on the command input unit 11), and a step S306 is afterward performed. If no first motion acts on the command input unit 11, then the step S305 is repeated.

Step S306 is performed for a focus adjustment, wherein the control unit 14 generates a signal to the lens unit 17 to enable focus adjusting function, and a step S307 is afterward performed.

Step S307 is performed to make a judgment in the second stage operation mode. In detail, the command input unit 11 generates the second status signal to the control unit 14 when the user performs the second motion on the command input unit 11 (for example, full pressing the command input unit 11, or another short touch on the command input unit 11, or a long touch on the command input unit, or performing a second slide motion on the command input unit 11), and a step S308 is afterward performed. If no second motion acts on the command input unit 11, a step S310 is afterward performed.

Step S308 is performed for a photographic exposure, wherein the control unit 14 generates a signal to enable the shutter unit 15 for exposing the light sensing unit 16, and a step 309 is afterward performed.

Step S309 is performed for storing image data. In detail, the light sensing unit 16 transforms the received light signal into the electric signal, and the electrical signal is processed by digital image processing and stored as image data in the memory unit (not shown), thereby finishing the image capture. Afterward, step S310 is performed.

Step S310 is performed to make a judgment in the third stage operation mode. Specifically, the second motion is released after the photographic exposure and storage of image data, and the third stage operation mode is entered. Two operations can be selected after the judgment in the third stage operation mode. The first operation is that the process returns to the step S307 to repeat the judgment in the second stage operation mode, if there is no second motion acting on the command input unit 11 in the aforementioned step S307 or the user's motion is changed from the second motion (for example, full pressing) to the first motion (for example, half pressing) after the step S309. Under such a circumstance, the command input unit 11 generates the first status signal to the control unit 14, and the process returns to the step S307 to repeat the judgment in the second stage operation mode. The second operation is that the process returns to the step S305 to repeat the judgment in the first stage operation mode, if the first motion acting on the command input unit 11 is released after the step S307 (in which there is no second motion acting on the command input unit 11) or the step S309 (in which the second motion is released). Under such a circumstance, the command input unit 11 generates the release status signal to the control unit 14, and the step S305 is performed to repeat the judgment in the first stage operation mode.

Step S311 is performed to disable the vibration compensation unit 18, wherein the control unit 14 generates a signal to the vibration compensation unit 18 to disable the vibration compensation unit 18, and the step S312 is afterward performed.

Step S312 is performed to make a judgment in the first stage operation mode. In detail, the command input unit 11 generates the first status signal to the control unit 14 when the user performs the first motion on the command input unit 11 (for example, half pressing the command input unit 11, or a touch on the command input unit 11, or performing a first slide motion on the command input unit 11), and a step S313 is afterward performed. If no first motion acts on the command input unit 11, then the step S312 is repeated.

Step S313 is performed to enable the vibration compensation unit 18, wherein the control unit 14 generates the first status signal to the vibration compensation unit 18 for enabling the vibration compensation unit 18, and a step S314 is afterward performed

Step S314 is performed for a focus adjustment, wherein the control unit 14 generates a signal to the lens unit 17 to enable focus adjusting function, and a step S315 is afterward performed.

Step S315 is performed to make a judgment in the second stage operation mode.

In detail, the command input unit 11 generates the second status signal to the control unit 14 when the user performs the second motion on the command input unit 11 (for example, full pressing the command input unit 11, or another short touch on the command input unit 11, or a long touch on the command input unit, or performing a second slide motion on the command input unit 11), and a step S308 is afterward performed. If no second motion acts on the command input unit 11, a step S318 is afterward performed.

Step S316 is performed for a photographic exposure, wherein the control unit 14 generates a signal to enable the shutter unit 15 for exposing the light sensing unit 16, and a step 317 is afterward performed.

Step S317 is performed for storing image data. In detail, the light sensing unit 16 transforms the received light signal into the electric signal, and the electrical signal is processed by digital image processing and stored as image data in the memory unit (not shown), thereby finishing the image capture. Afterward, a step S318 is performed.

Step S318 is performed to make a judgment in the third stage operation mode. Specifically, the second motion is released after the photographic exposure and storage of image data, and the third stage operation mode is entered. Two operations can be selected after the judgment in the third stage operation mode. The first operation is that the process returns to the step S315 to repeat the judgment in the second stage operation mode, if there is no second motion acting on the command input unit 11 in the aforementioned step S315 or the user's motion is changed from the second motion (for example, full pressing) to the first motion (for example, half pressing) after the step S317. Under such a circumstance, the command input unit 11 generates the first status signal to the control unit 14, and the process returns to the step S315 to repeat the judgment in the second stage operation mode. The second operation is that the process goes to the step S319 to disable the vibration compensation unit 18, if the first motion acting on the command input unit 11 is released after the step S315 (in which there is no second motion acting on the command input unit 11) or the step S317 (in which the second motion is released). Under such a circumstance, the command input unit 11 generates the release status signal to the control unit 14, and the step S319 is performed to disable the vibration compensation unit 18.

Step S319 is performed to disable the vibration compensation unit 18. After receiving the release status signal from the command input unit 11, the control unit 14 generates a signal to the vibration compensation unit 18 to disable the vibration compensation unit 18, and the step S312 is afterward performed.

For the image capture device 1 in accordance with the embodiment of the invention, if the zoom ratio exceeds or equals the predetermined value, then the vibration compensation unit 18 is enabled. On the other hand, if the zoom ratio is less than the predetermined value, then the vibration compensation unit 18 is disabled, wherein the vibration compensation unit 18 can be enabled again if the first motion acts on the command input unit to enter the first stage operation mode. After the second motion acts on the command input unit 11 for performing a photographic exposure and storing image data, the vibration compensation unit 18 will be disabled again if the second motion is released and the first motion is afterward released. The comparison between the zoom ratio and the predetermined value is repeated to enable or disable the vibration compensation unit 18 whenever the user touches the focus adjusting button 13 to adjust the zoom ratio of the lens unit 17.

In the aforementioned embodiment, the initial value of the zoom ratio and the predetermined value can be set in the image capture device 1; however, the user can adjust the predetermined value for personal purpose, which is also within the scope of the invention.

In the aforementioned embodiment, every step in the anti-shake control method of the invention is not to limit the scope of the invention. The person skilled in the art can have various modifications according to the embodiments of the invention, which is also within the scope of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An anti-shake control method of an image capture device, comprising:
comparing a zoom ratio of the image capture device with a predetermined value;
entering a vibration compensation mode when the zoom ratio is greater than or equals the predetermined value;
exiting the vibration compensation mode when the zoom ratio is smaller than the predetermined value; and
entering the vibration compensation mode when the zoom ratio is smaller than the predetermined value and a first motion acts on a command input unit of the image capture device.

2. The anti-shake control method of an image capture device as claimed in claim 1, wherein the command input unit is a physical shutter button or a touch panel.

3. The anti-shake control method of an image capture device as claimed in claim 1, wherein the first motion comprises half pressing the command input unit, or a short touch on the command input unit, or performing a first sliding motion on the command input unit.

4. The anti-shake control method of an image capture device as claimed in claim 1, further comprising: performing a focus adjustment after entering the vibration compensation mode by the first motion acting on the command input unit.

5. The anti-shake control method of an image capture device as claimed in claim 4, after performing the focus adjustment, further comprising: exiting the vibration compensation mode when the first motion is released and a second motion has not acted on the command input unit yet.

6. The anti-shake control method of an image capture device as claimed in claim 4, after performing the focus adjustment, further comprising: performing a photographic exposure when a second motion acts on the command input unit.

7. The anti-shake control method of an image capture device as claimed in claim 6, wherein the second motion comprises: full pressing the command input unit, or another short touch on the command input unit, or a long touch on the command input unit, or performing a second sliding motion on the command input unit.

8. The anti-shake control method of an image capture device as claimed in claim 6, after performing the photographic exposure, further comprising: exiting the vibration compensation mode when the first motion and second motion are released.

9. The anti-shake control method of an image capture device as claimed in claim 1, wherein the predetermined value is 15 times.

10. An image capture device, comprising:
a lens unit including an adjustable focus to have a zoom ratio;
a vibration compensation unit; and
a control unit, enabling or disabling the vibration compensation unit according to the zoom ratio of the lens unit.

11. The image capture device as claimed in claim 10, further comprising a command input unit, wherein the control unit enables or disables the vibration compensation unit in accordance with an external motion acting on the command input unit.

12. The image capture device as claimed in claim 10, further comprising a focus adjusting button to control the focus of the lens unit through the control unit.

13. The image capture device as claimed in claim 10, wherein the predetermined value is 15 times.
